(19) United States
(12) Patent Application Publication
(10) Pub. No.: US 2018/0161721 A1
(43) Pub. Date: Jun. 14, 2018

(54) IMPROVED DIMETHYL ETHYLENE GLYCOL COMPOSITION FOR ACID GAS TREATMENT

(71) Applicant: Dow Global Technologies LLC, Midland, MI (US)

(72) Inventors: Ross E. Dugas, Pearland, TX (US); Jonathan W. Leister, Manvel, TX (US); Jack D. Mcjannett, Calgary (CA)

(21) Appl. No.: 15/580,863

(22) PCT Filed: Jun. 3, 2016
(86) PCT No.: PCT/US2016/035774

§ 371 Date: Dec. 8, 2017

Related U.S. Application Data
(60) Provisional application No. 62/184,929, filed on Jun. 26, 2015.

(51) Int. Cl. B01D 53/14; C10L 3/10; C01B 3/52

(52) U.S. Cl. CPC B01D 53/1493; B01D 53/1456; C10L 3/102; C01B 2203/0415; B01D 2252/2026; C10L 2290/541; C01B 3/52

(57) ABSTRACT

An improved composition and method for acid gas treatment, comprising an effective amount of tetraethylene glycol dimethyl ether in combination with other alkyl ethers of alkylene glycols. Utilization of a mixture consisting of 60 to 84 weight percent tetraethylene glycol dimethyl ether produces significant benefits in freeze point reduction. A solvent based said mixture of 60 to 84 weight percent tetraethylene glycol dimethyl ether can be used neat or as an aqueous mixture or can be added to the existing recirculating solvent stream to change the concentration of tetraethylene glycol dimethyl ether to a satisfactory level.

### BACKGROUND OF THE INVENTION

Dialkyl ethers of polyalkylene glycols are well known in the gas treatment art as solvents for acidic gases such as carbon dioxide (CO₂), hydrogen sulfide (H₂S), carbonyl sulfides (COS), hydrogen cyanide (HCN), carbon disulfide (CS₂), mercaptans, and the like. Typical of the numerous disclosures of such solvents in the art are U.S. Pat. Nos. 3,737,392; 3,824,766; 3,837,143; 4,044,100; 4,581,154; 4,741,745; 4,946,620, 6,602,443; and 6,592,779 among others.

According to such references, it is well known that the dialkyl ethers of polyalkylene glycols, and in particular, for present purposes, the dimethyl ethers, comprise mixtures of polyalkylene products typically ranging from 3 to about 9 units of the ethylene oxide-derived moiety, —(C₂H₄O)—. U.S. Pat. No. 4,581,154 is particularly informative in that regard. That reference discloses a bell curve distribution of —(C₂H₄O)— homologs, with the peak at 50 weight percent of the 3-homolog and a maximum content of 40 weight percent of the 4-homolog. That reference further teaches that the most preferred composition, at least for low temperature use, has a distribution of the 3- and 4-homologs at 33 weight percent each. However, U.S. Pat. No. 6,592,779 discloses that the homolog 4 has excellent properties whereas homolog 3 has undesirable volatility while homologs of 5 and greater have undesirable viscosity. That reference further discloses that pure homolog 4 would be best but “well-known methods of preparation do not produce pure products, so as a matter of economic convenience, a certain amount of other homologs may be tolerated”. That reference further teaches that the most preferred composition has a distribution of greater than 80 weight percent of the 4-homolog in the substantial absence of the 3-homolog.

While the compositions of the prior art are generally effective for their intended purpose, they are not optimal. More specifically, it would be desirable to have a gas treatment composition having improved low temperature performance which provides effective removal of at least one key acidic component of the gas being treated. The present invention responds to that need.

### SUMMARY OF THE INVENTION

The present invention is a solvent composition for removal of acid gas impurities from natural gas, hydrocarbon gas, or syngas streams and method of use thereof wherein said composition consists essentially of a mixture of dimethyl ethers of polyethylene glycols of the formula CH₃O(C₂H₄O)ₓCH₃ wherein x is from 3 to 9 and wherein x equals 4 in an amount from 60 to 84 weight percent and the combination of x equals 3, x equals 5, and x equals 6 is 16 to 40 weight percent of the total weight of the mixture of dimethyl ethers, preferably x equals 3 is present in an amount from 1 to 5 weight percent, x equals 5 is present in an amount from 7 to 18 weight percent, and x equals 6 is present in an amount from 1 to 12, wherein weight percent is based on the total weight of the mixture of dimethyl ethers.

In another embodiment of the composition of the present invention disclosed herein above, x equals 4 is present in an amount of 70 to 82 weight percent of the total dimethyl ethers and for the combination of x equals 3, x equals 5, and x equals 6 is present in an amount of 18 to 30 weight percent of the total weight of the dimethyl ethers, preferably x equal 3 for 2 to 4 weight percent, x equals 5 for 8 to 15 weight percent, and x equals 6 for 2 to 9 weight percent based on the total weight of the mixture of dimethyl ethers.

Another embodiment of the present invention is a method for removal of acid gas impurities from a gas stream comprising contacting the stream with a solvent composition consisting essentially of the mixture of dimethyl ethers of polyethylene glycols disclosed herein above.

In another embodiment of the method of the present invention, the solvent composition is added to a solvent composition already being used to treat the acid gas.

### DETAILED DESCRIPTION OF THE INVENTION

As used herein, the terms “gas,” “acid gas,” and the like, are intended to refer to natural gas, hydrocarbon gas, syngas, steam reformer-type gases, and any other gas containing acidic, gaseous components which are to be removed by treatment with a solvent.

The present invention is a solvent composition for removal of acid gas impurities (i.e., one or more of CO₂, H₂S, COS, HCN, CS₂, mercaptans, and the like) from natural gas, hydrocarbon gas, or syngas streams and method of use thereof wherein said composition consists essentially of a mixture of dimethyl ethers of polyethylene glycols of the formula:

CH₃O(C₂H₄O)ₓCH₃

wherein x is from 3 to 9. The various dimethyl ethers of polyethylene glycols homologs are described by the number of ethoxylates (also represented by —(C₂H₄O)—) each comprises. A specific homolog is sometimes referred to as the “x-mole ethoxylate”, for example when x is equal to 4, that homolog may be referred to as the 4-mole ethoxylate, or just the 4-mole, when x is equal to 5, that homolog may be referred to as the 5-mole ethoxylate, or just the 5-mole, etc. Optionally, different homologs may be describe by what x is equal to, for example x is equal to 3, x is equal to 4, x is equal to 5, x is equal to 6, x is equal to 7, x is equal to 8, or x is equal to 9.

The present invention provides its improvement over the prior art by specifying the weight percent of the 4-mole ethoxylate of dimethyl ether present in the solvent consisting of a mixture of dimethyl ethers consisting of 3-mole to 9-mole ethoxylates, said solvent being used to remove one or more acid gas from a gas stream, particularly an acid gas such as carbon dioxide from a natural gas stream. As will be illustrated in the examples below, it has been unexpectedly found that when the 4-mole ethoxylate of dimethyl ether is present in an amount of equal to or greater than 60 weight percent and equal to or less than 84 weight percent the freeze point of the solution is unexpectedly lowered as compared to mixtures of dimethyl ethers having less than 60 weight percent 4-mole or mixtures having greater than 84 weight percent 4-mole. Accordingly, the present invention is particularly useful in commercial operations wherein lower temperatures are encountered.

Solvents consisting of mixtures of dimethyl ethers of polyethylene glycols with high levels (e.g., greater than 84 weight percent) of the 4-mole ethoxylate of dimethyl ether (i.e., tetraethylene glycol dimethyl ether) are known to have excellent properties for the removal of acid gases, especially CO₂ from methane, natural gas, syngas and hydrocarbon gases in general. Its combination of excellent affinity for the acid gases, low viscosity and low vapor pressure, makes it superior to any of the other homologs in the series for use in acid gas treatment. However, said solvents consisting of high levels of the 4-mole ethoxylate of dimethyl ether do not always demonstrate good freeze point protection. Moreover, solvents consisting of dimethyl ethers of polyethylene glycols with lower levels (e.g., less than 60 weight percent) of 4-mole ethoxylate of dimethyl ether are also known to be effective for the removal of acid gases, especially CO₂, from methane, natural gas, syngas and hydrocarbon gases in general and have similar freeze point protection as compared to solvents with higher 4-mole levels (e.g., greater than 84 weight percent).

We have found that by limiting the amount of the 4-mole ethoxylate in a mixture of diethyl ethers to between 60 to 84 weight percent of the total weight of the dimethyl ether mixture provides effective acid gas removal and maximizes freezing point depression. In one embodiment of the present invention, the amount of other homologs, i.e., 3-mole, 5-mole, and 6-mole are present in an amount of from 16 to 40 weight percent. In any such combination, it is preferred that tetraethylene glycol dimethyl ether, where x equals 4, be present in a concentration equal to or greater than 60 percent by weight, more preferably equal to or greater than 65 percent by weight, and most preferably equal to or greater than 70 percent by weight based on the total weight of the mixture of dimethyl ethers. In any such combination, it is preferred that tetraethylene glycol dimethyl ether, where x equals 4, be present in a concentration equal to or less than 84 percent by weight, more preferably equal to or less than 83 percent by weight, and most preferably equal to or less than 82 percent by weight based on the total weight of the mixture of dimethyl ethers.

It is preferred that the amount of triethylene glycol dimethyl ether, where x equals 3, is equal to or greater than 1 percent by weight and more preferably equal to or greater than 2 percent by weight based on the total weight of the mixture of dimethyl ethers. It is preferred that the amount of triethylene glycol dimethyl ether, where x equals 3, is equal to or less than 5 percent by weight and more preferably equal to or less than 4 percent by weight, based on the total weight of the mixture of dimethyl ethers.

It is preferred that the amount of pentaethylene glycol dimethyl ether, where x equals 5, is equal to or greater than 7 percent by weight and more preferably equal to or greater than 8 percent by weight based on the total weight of the mixture of dimethyl ethers. It is preferred that the amount of pentaethylene glycol dimethyl ether, where x equals 5, is equal to or less than 18 percent by weight and more preferably equal to or less than 15 percent by weight based on the total weight of the mixture of dimethyl ethers.

It is preferred that the amount of the hexaethylene glycol dimethyl ethers where x equals 6, is equal to or greater than 1 percent by weight and more preferably equal to or greater than 2 percent by weight based on the total weight of the mixture of dimethyl ethers. It is preferred that the combined amount for the hexaethylene glycol dimethyl ethers where x equals 6, is equal to or less than 12 percent by weight and more preferably equal to or less than 9 percent by weight based on the total weight of the mixture of dimethyl ethers.

In one embodiment of the present invention, a preferred dimethyl ether composition consists of x equal to 4 in an amount of 60 to 84 weight percent and the mixture of x equals 3, x equals 5, and x equals 6 is present in an amount of 16 to 40 weight percent of the total weight of the mixture of dimethyl ethers, more preferably an amount from 1 to 5 weight percent for x equals 3, an amount from 7 to 18 weight percent for x equals 5, and an amount from 1 to 12 weight percent for x equals 6, wherein weight percent is based on the total weight of the mixture of dimethyl ethers.

In one embodiment of the present invention, a preferred dimethyl ether composition consists of x equal to 4 in an amount of 70 to 82 weight percent and the mixture of x equals 3, x equals 5, and x equals 6 is present in an amount of 18 to 30 weight percent of the total weight of the mixture of dimethyl ethers, more preferably an amount from 2 to 4 weight percent for x equals 3, an amount from 8 to 15 weight percent for x equals 5, and an amount from 2 to 9 weight percent for x equals 6, wherein weight percent is based on the total weight of the mixture of dimethyl ethers.

In one embodiment of the present invention the dimethyl ether composition does not contain any other solvent and/or water (in other words it is referred to as neat).

In one embodiment of the present invention the dimethyl ether composition is an aqueous mixture comprising 15 weight percent or less water, preferably 10 weight percent or less water, and more preferably 5 weight percent or less water.

One embodiment of the present invention is a method for removal of acid gas impurities (i.e., one or more of CO₂, H₂S, COS, HCN, CS₂, mercaptans, and the like) from a gas stream, preferably a natural gas stream, comprising contacting the stream with a solvent composition consisting of a mixture of dimethyl ethers of polyethylene glycols of the formula CH₃O(C₂H₄O)ₓCH₃ wherein x is from 3 to 9 and wherein x equal to 4 in an amount of 60 to 84 weight percent and the mixture of x equals 3, x equals 5, and x equals 6 is present in an amount of 16 to 40 weight percent of the total weight of the mixture of dimethyl ethers, more preferably an amount from 1 to 5 weight percent for x equals 3, an amount from 7 to 18 weight percent for x equals 5, and an amount from 1 to 12 weight percent for x equals 6, wherein weight percent is based on the total weight of the mixture of dimethyl ethers.

One embodiment of the present invention is a method for removal of one or more acid gas impurities from a gas stream comprising contacting the stream with a solvent composition consisting of a mixture of dimethyl ethers of polyethylene glycols of the formula CH₃O(C₂H₄O)ₓCH₃ wherein x is from 3 to 9 and wherein x equal to 4 in an amount of 70 to 82 weight percent and the mixture of x equals 3, x equals 5, and x equals 6 is present in an amount of 18 to 30 weight percent of the total weight of the mixture of dimethyl ethers, more preferably an amount from 2 to 4 weight percent for x equals 3, an amount from 8 to 15 weight percent for x equals 5, and an amount from 2 to 9 weight percent for x equals 6, wherein weight percent is based on the total weight of the mixture of dimethyl ethers.

In another embodiment of the process of the present invention, the solvent composition consisting of a mixture of dimethyl ethers of polyethylene glycols is added neat (i.e., no water or other solvent) or as an aqueous solution.

In another embodiment of the process of the present invention, the solvent composition consisting of a mixture of dimethyl ethers of polyethylene glycols is added to a solvent composition already being used to treat the acid gas.

### Examples

Examples 1 and 2 and Comparative Examples A to E are mixture of dimethyl ethers of polyethylene glycols of the formula CH₃O(C₂H₄O)ₓCH₃ wherein x is 3 to 9. For Examples 1 and 2 and Comparative Examples A to E, the weight percent 4 homologs (where x=4) and combined weight percent for the remaining 3, 5, and 6 homologs are given in Table 1 along with the molecular weight (Mw) in g/mol of the dimethyl ether homologs and freezing point in ° C. Weight percents and molecular weights are based on total combined weight of all the dimethyl ether homologs.

Freezing point is obtained by dipping a vial of the solution into a cold bath while providing agitation to help facilitate nucleation of crystals. Once crystals are observed the sample is removed from the bath and crystals are redissolved while the sample is slightly heated by ambient air. This cycle is repeated multiple times until the observed temperature of crystal formation and temperature of crystal solution are the same. This cyclic process is necessary since dimethyl ethers of polyethylene glycols are prone to supercooling. The temperature of the sample is measured throughout the entire measurement process.

TABLE 1

| | | | 3, 5, 6 | | |
|---|---|---|---|---|---|
| | | 4 homologs | homologs | Mw | Freezing Point |
| Com. Ex. | Example | wt % | wt % | g/mol | ° C. |
| A | | 21 | 57 | 269 | −21 |
| B | | 28 | 52 | 264 | −21 |
| C | | 39 | 45 | 257 | −22 |
| D | | 56 | 33 | 245 | −27 |
| | 1 | 73 | 21 | 234 | −35 |
| | 2 | 81 | 16 | 229 | −34 |
| E | | 90 | 9 | 225 | −29 |

Examples 3 and 4 and Comparative Examples F to J are aqueous mixture of dimethyl ethers of polyethylene glycols of the formula CH₃O(C₂H₄O)ₓCH₃ wherein x is 3 to 9 comprising 5 weight percent water. For Examples 3 and 4 and Comparative Examples F to J, the weight percent 4 homologs (where x=4) and combined weight percent for the remaining 3, 5, and 6 homologs are given in Table 2 along with the molecular weight (Mw) in g/mol and freezing point in ° C. Weight percents and molecular weights are based on total combined weight of all the dimethyl ether homologs.

TABLE 2

| | | | 3, 5, 6 | | |
|---|---|---|---|---|---|
| | | 4 homologs | homologs | Mw | Freezing Point |
| Com. Ex. | Example | wt % | wt % | g/mol | ° C. |
| F | | 21 | 57 | 269 | −25 |
| G | | 28 | 52 | 264 | −27 |
| H | | 39 | 45 | 257 | −30 |
| | I | 56 | 33 | 245 | −34 |
| | 3 | 73 | 21 | 234 | −40 |
| | 4 | 81 | 16 | 229 | −39 |
| J | | 90 | 9 | 225 | −34 |

What is claimed is:

1. A solvent composition for removal of acidic gaseous impurities from natural gas, hydrocarbon gas, or syngas streams, consisting essentially of a mixture of dimethyl ethers of polyethylene glycols of the formula CH₃O(C₂H₄O)ₓCH₃ wherein x is 3 to 9 and wherein x equals 4 in an amount from 60 to 84 weight percent and the combination of x equals 3, x equals 5, and x equals 6 is 16 to 40 weight percent of the total weight of the mixture of dimethyl ethers.

2. A composition of claim 1 wherein x equals 3 in an amount from 1 to 5 weight percent, x equals 5 in an amount from 7 to 18 weight percent, and x equals 6 in an amount from 1 to 12, wherein weight percent is based on the total weight of the mixture of dimethyl ethers.

3. A composition of claim 1 wherein x equals 4 for 70 to 82 weight percent of the total dimethyl ethers and for the combination of x equals 3, x equals 5, and x equals 6 is 18 to 30 weight percent of the total weight of the dimethyl ethers.

4. A composition of claim 3 wherein x equal 3 for 2 to 4 weight percent, x equals 5 for 8 to 15 weight percent, and x equals 6 for 2 to 9 weight percent based on the total weight of the mixture of dimethyl ethers.

5. A method for removal of acidic gaseous impurities from a gas stream comprising contacting the stream with a solvent composition consisting essentially of a mixture of dimethyl ethers of polyethylene glycols of the formula CH₃O(C₂H₄O)ₓCH₃ wherein x is from 3 to 9 and x equals 4 in an amount from 60 to 84 weight percent and the combination of x equals 3, x equals 5, and x equals 6 is present in an amount of 16 to 40 weight percent of the total weight of the mixture of dimethyl ethers.

6. A method of claim 5 wherein the solvent composition is added to a solvent composition already being used to treat the acid gas.

7. A method of claim 5 wherein the solvent composition is added neat or as an aqueous solution.
